(19) United States
(12) Patent Application Publication
(10) Pub. No.: US 2005/0077747 A1
(43) Pub. Date: Apr. 14, 2005

(54) Frame element for mounting in the lower area of the back window of a motor vehicle and a vehicle with one such element

(75) Inventors: Francois De Gaillard, Mouilleron en Pareds (FR); Martin De Waal, Assendelft (NL); Jean-Luc Guicheteau, Cholet (FR); Izumi Kimoto, Saeki-gun (JP); Michael Kolbl, Neuried (DE); Peter Mitterbauer, Gmunden (AT); Martin Pollak, Germering (DE); Claudio Ivano Righetti, Torino (IT); Miriam Schonauer, Garching (DE); Sigeru Ueki, Higashihiroshima-City (JP); Bernhard Vecchioni, Oxford, MI (US)

Correspondence Address: NIXON PEABODY, LLP, 401 9TH STREET, NW, SUITE 900, WASHINGTON, DC, 20004-2128, US

(73) Assignee: Webasto Vehicle Systems International GmbH, Stockdorf (DE)

(21) Appl. No.: 10/623,805

(22) Filed: Jul. 22, 2003

(30) Foreign Application Priority Data
Jul. 24, 2002 (DE) 102 33 746.2

(51) Int. Cl. B60R 9/06

(52) U.S. Cl. 296/26.11

(57) ABSTRACT

A cargo support having a frame element (1) for mounting in the lower area (15) of a rear window (6) of a motor vehicle (2). The frame element (1) can be mounted to have a first mounting position framing the rear window (6) on the motor vehicle (2) and a second mounting position in which it is essentially horizontal for supporting cargo (20) on the vehicle. A second frame member (5) can be provided for co-acting with the window area frame element (1) for support cargo.

### BACKGROUND OF THE INVENTION

1. Field of the Invention

The invention relates to a frame element for mounting in the lower area of the back window of a motor vehicle. Furthermore, the invention relates to a vehicle with such an element.

2. Description of Related Art

Published German Patent Application DE 44 41 853 A1 discloses a motor vehicle with a bumper which is located on the back end area of a motor vehicle and which can be moved a variable distance between a rest position and an extended position by at least one holding element. With the bumper in the extended position, it can be used as a carrier for cargo. The motor vehicle with the described bumper is suited for transport of cargos which can be placed on the bumper.

### SUMMARY OF THE INVENTION

A primary object of the present invention is to provide a frame element for mounting on a vehicle which enables diverse use of the vehicle as cargo carrier.

Furthermore, it is another object of the invention to provide available a vehicle with such a frame element.

These objects are achieved by the provision of a frame element which has a first mounting position framing the rear window of the motor vehicle and a second mounting position in which it is essentially horizontal for use as a cargo support.

The frame element of the invention is designed for mounting in the lower area of the back window of a vehicle, and the frame element can be mounted on the motor vehicle in a first mounting position framing the back window in part or completely and in the second mounting position can be mounted on the vehicle essentially horizontally (therefore extended or folded out) for use as a cargo support.

The frame element of the invention can be integrated when not in use in an especially space-saving manner into the rear area and the area of the rear window of the motor vehicle. If necessary, the frame element can be pulled out or folded out, and due to its elevated mounting in the lower area of the back window, it also allows transport of bulky and larger cargos.

Advantageously, the frame element is made bow-shaped and can be stowed with little space consumption when not in use in the first mounting position on or in the vehicle. Cargos can also be reliably encompassed on several sides by the bow-shaped configuration.

According to another advantageous embodiment, the frame element is pivotally mounted via hinges on the vehicle so that the frame element when not in use can be folded essentially onto the outside of the motor vehicle in a space-saving manner. The interior of the motor vehicle remains freely available for other possible applications.

For safe transport when the frame element is in use and not in use it can be advantageously locked in the first and/or the second mounting position on the motor vehicle.

In order to keep the largest possible area of the back window free for viewing, it can be advantageous to push in the frame element in the first mounting position when not in use in the vehicle for countersinking. The frame element then disappears when not in use at least in part within the vehicle without the opening area of the back window being diminished.

By integrating the frame element in the first mounting position, when not in use, into the body of the vehicle, it does not detract from the overall visual impression of the motor vehicle. At first glance, it cannot be seen on the vehicle that there is a folding or extensible frame element for use as a cargo support in the rear area or in the lower area of the back window.

The possibilities of conveying cargos are expanded by the provision of an additional frame element for joint use with an existing frame element. The other frame element is also mounted in the rear area of the motor vehicle, and jointly with the first frame element, can enable especially versatile attachment and conveyance of cargos.

The other frame element can be folded onto the vehicle in the first mounting position or can be countersunk into the vehicle. In this first mounting position, the other frame element is not in use and can thus be housed in a space-saving manner on or in the vehicle.

In the second mounting position, when used as a cargo support, the other frame element can be mounted essentially horizontally on the vehicle.

By the interaction of the two frame elements, cargos can be attached and transported in an especially versatile manner.

The vehicle as in accordance with the invention has a frame element as described above, and when the frame elements are not in use it, can be used as a conventional vehicle. If there is the necessity of transporting cargos, the frame element(s) of the invention can be pulled out of the vehicle or folded down from it so that, within a short time, a vehicle with distinctly improved transport possibilities is formed.

Embodiments of the invention are explained greater detail below with reference to the accompanying drawings.

### BRIEF DESCRIPTION OF THE DRAWINGS

FIG. 1 shows a motor vehicle with a frame element in a second mounting position for use as a cargo support,

FIG. 2 shows a motor vehicle as shown in FIG. 1 with frame element in the first mounting position when not in use as a cargo support,

FIG. 3 shows the motor vehicle as shown in FIG. 2 with another embodiment of a frame element,

FIG. 4 shows the motor vehicle with cargo attached to the frame elements, and

FIG. 5 is a view similar to that of FIG. 1, but illustrating an embodiment with a modified second mounting position.

### DETAILED DESCRIPTION OF THE INVENTION

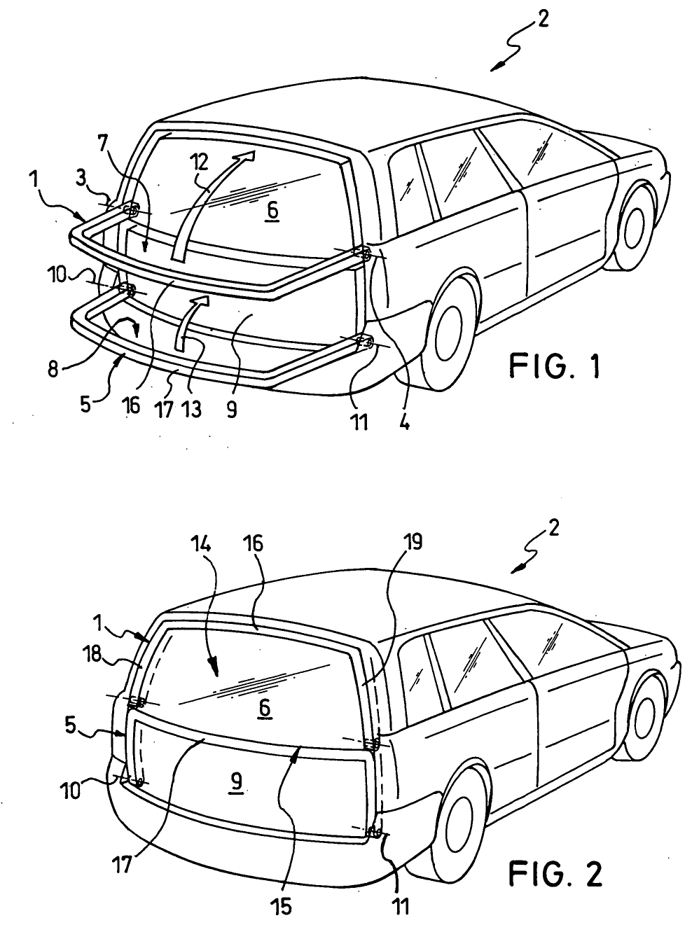

FIG. 1 shows a motor vehicle 2 with a first schematically shown frame element 1 (for example, made of a pipe or tube element) in an essentially horizontal second mounting position for use as a cargo support. Furthermore, another schematically depicted frame element 5 is, likewise, shown in the essentially horizontal second mounting position, likewise, for use as a cargo support, especially in conjunction with the frame element 1. The frame elements 1, 5 have U or bow shape and are used in the illustrated second mounting position also as collision protection.

In the intermediate spaces 7, 8, according to FIG. 1, cargo can be held for transport on the vehicle 2 between the frame elements 1, 5 and the rear area 9 of the motor vehicle 2 (FIG. 4), in a conventional manner, for example, by belts, screws or other fastenings,.

In FIGS. 1 & 2, the frame elements 1, 5 are mounted on the vehicle 2 via schematically shown hinges 3, 4 and 10, 11 and can be folded against the vehicle 2 in the directions 12, 13. Here especially, the frame element 1 can be folded against the vehicle 2 such that the back window 6 of the motor vehicle 2 is framed. Thus, a viewing area 14 through the back window 6 remains for unhindered use. The frame element 1 is mounted in the lower area 15 of the back window 6, and according to FIG. 2, can be folded onto the back window 6 in the first mounting position when not in use, and thus, can be unobtrusively fitted into the rear body shape of the motor vehicle 2.

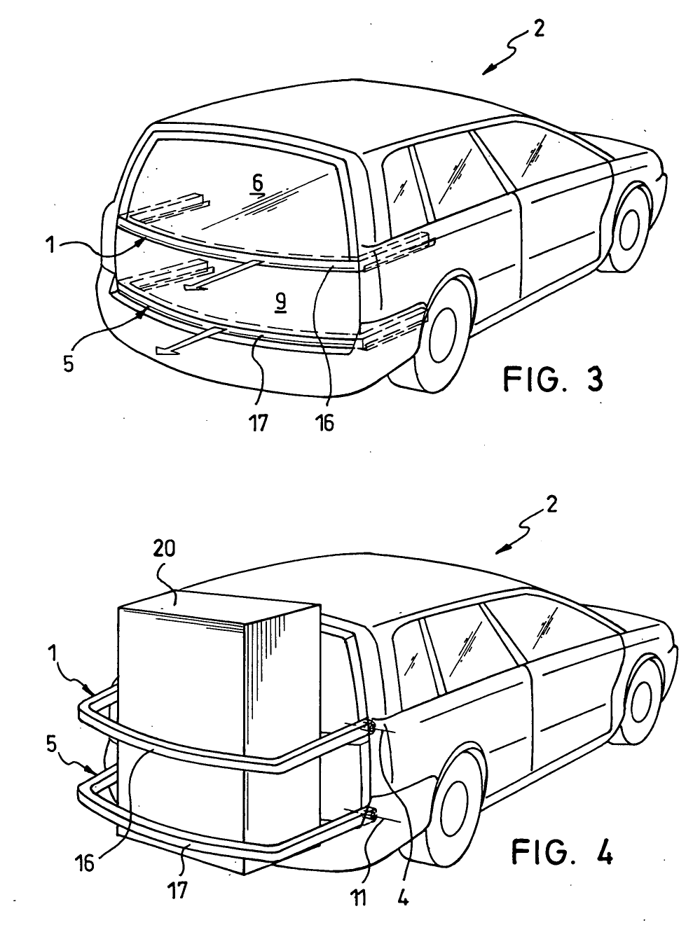

According to another embodiment as shown in FIG. 3, the frame elements 1, 5, when not in use, can be pushed into the vehicle 2 in the first mounting position so that only the transverse members 16, 17 of the frame elements 1, 5 in the first mounting position can be viewed from the outside. In this way, the frame elements 1, 5 when not in use are likewise integrated unobtrusively into the rear body shape of the motor vehicle 2. The viewing area 14 through the back window 6 remains essentially unchanged.

In the embodiment shown in FIG. 2, the back window 6 is framed by the transverse member 16 and the lengthwise members 18, 19 of the frame element 1.

In the embodiment shown in FIG. 3, the back window 6 is partially framed by the transverse member 16 of the frame element 1.

FIG. 4 shows the attachment of cargo 20 within the frame elements 1, 5 which are in the mounting positions. The cargo 20 can be secured to the frame elements 1, 5 in a conventional manner by belts, screw fasteners or other fasteners.

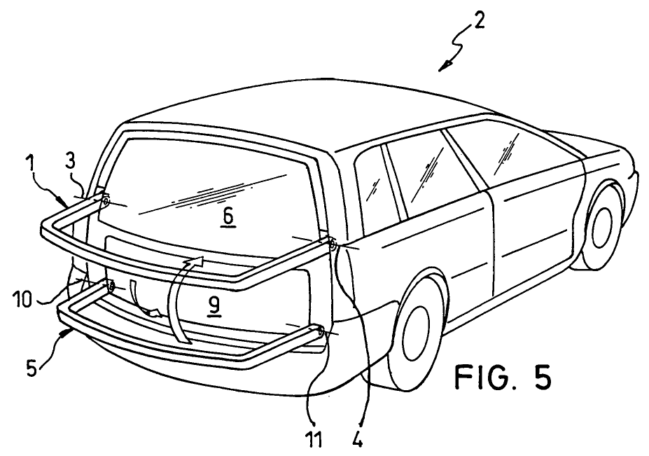

FIG. 5 in which the frame element 5′ has a reduced width and height to an extend that it can nest within the frame element 1 in the inactive, first position. In this case, the frame element 1 (shown in the second mounting position) is swung downward to its inactive, first mounting position about hinges 3, 4, (instead up to around the window) after the lower frame element 5′ has been swung upward about the hinges 10, 11 to lie against the vehicle 2. Thus, in their inactive, first mounting positions, both frame elements 1, 5 lie flat agaisnt the rear door area 9 below the window 6 with the hinged legs of the frame element 1 flanking the outer sides of the hinged legs the frame element 5′ with the cross piece of the frame element 1 lying below the frame element 5′ and the cross piece of the frame element 5′ lying just below the window 6.

1. Cargo support comprising at least a window area frame element and a mounting for attachment of the frame element at a lower area of a rear window of a motor vehicle, said mounting enabling the frame element to be moved between a first mounting position at least partially framing the rear window of the motor vehicle and a second mounting position in which the frame is essentially horizontal for supporting a cargo.

2. Cargo support as claimed in claim 1, wherein the frame element is has a U or bow shape.

3. Cargo support as claimed in claim 2, wherein the mounting is a pivotal mounting with hinges for attachment on the vehicle.

4. Cargo support as claimed in claim 2, wherein the frame element is lockable on the vehicle in the first mounting position.

5. Cargo support as claimed in claim 2, wherein the frame element is lockable on the vehicle in the second mounting position.

6. Cargo support as claimed in claim 2, wherein mounting comprises a slide mount for enabling the frame element to be pushed into the vehicle.

7. Cargo support as claimed in claim 1, wherein the frame element is adapted for being integrated into a body of the vehicle in the first mounting position

8. Cargo support as claimed in claim 1, further comprising a second frame element and a second mounting for attachment of the second frame on the vehicle for joint use with the window area frame element for supporting cargo.

9. Cargo support as claimed in claim 8, wherein mounting for the second frame element enables the second frame element to have a first mounting position folded onto or recessed into the vehicle.

10. Frame element (1) as claimed in claim 8 or 9, wherein the frame element (5) in the second mounting position can be mounted on the vehicle (2) essentially horizontally for use as a cargo support.

11. Motor vehicle, comprising a vehicle body having a rear window and a cargo support having at least a window area frame element and a mounting for attachment of the frame element at a lower area of the rear window of the motor vehicle body, said mounted enabling the frame element to be moved between a first mounting position at least partially framing the rear window of the motor vehicle body and a second mounting position in which the frame is essentially horizontal for supporting a cargo on the vehicle body.

12. Motor vehicle as claimed in claim 11, wherein the frame element is has a U or bow shape.

13. Motor vehicle as claimed in claim 12, wherein the mounting is a pivotal with hinges for attachment on the vehicle body.

14. Motor vehicle as claimed in claim 12, wherein the frame element is lockable on the vehicle body in the first mounting position.

15. Motor vehicle as claimed in claim 12, wherein the frame element is lockable on the vehicle body in the second mounting position.

16. Motor vehicle as claimed in claim 12, wherein mounting comprises a slide mount for enabling the frame element to be pushed into the vehicle body.

17. Motor vehicle as claimed in claim 11, wherein the frame element is adapted for being integrated into the vehicle body in the first mounting position

18. Motor vehicle as claimed in claim 11, further comprising a second frame element and a second mounting for attachment of the second frame on the vehicle body for joint use with the window area frame element for supporting the cargo.

19. Motor vehicle as claimed in claim 18, wherein mounting for the second frame element enables the second frame element to have a first mounting position folded onto or recessed into the vehicle.

20. Motor vehicle as claimed in claim 11, wherein frame element is adapted to coact with an upper surface of a bumper on the vehicle body for supporting the cargo

21. Cargo support comprising at least an upper frame element and a mounting for attachment of the upper frame element at a lower area of a rear window of a motor vehicle, said mounting enabling the upper frame element to be moved between a first mounting position lying essentially flush with a rear door of the motor vehicle and a second mounting position in which the upper frame is essentially horizontal, extending outward relative to the rear door for supporting a cargo.

22. Cargo support as claimed in claim 21, further comprising a lower frame element and a second mounting for attachment of the lower frame on the vehicle for joint use with the upper frame element for supporting cargo in an active second mounting position extending outward relative to the rear door, wherein the frame elements have a U or bow shape, wherein the mountings are pivotal mountings with hinges for attachment on the vehicle, and wherein the lower frame element is of a width and height that is small enough to enable the lower frame element to nest within the upper frame element against the vehicle rear door in inactive first positions thereof.

23. Motor vehicle, comprising a vehicle body having a rear door, a rear window and a cargo support having at least an upper frame element and a mounting attaching the upper frame element at a lower area of the rear window, said mounting enabling the upper frame element to be moved between a first mounting position lying essentially flush with the rear door of the motor vehicle and a second mounting position in which the upper frame is essentially horizontal, extending outward relative to the rear door for supporting a cargo.

24. Cargo support as claimed in claim 23, further comprising a lower frame element and a second mounting for attachment of the lower frame on the vehicle for joint use with the upper frame element for supporting cargo in an active second mounting position extending outward relative to the rear door, wherein the frame elements have a U or bow shape, wherein the mountings are pivotal mountings with hinges attached on the vehicle, and wherein the lower frame element is of a width and height that is small enough to enable the lower frame element to nest within the upper frame element against the vehicle rear door in inactive first positions thereof.

25. Cargo support as claimed in claim 23, further comprising a lower frame element and a second mounting for attachment of the lower frame on the vehicle for joint use with the upper frame element for supporting cargo in an active second mounting position extending outward relative to the rear door, wherein the frame elements have a U or bow shape, wherein the mountings are pivotal mountings with hinges attached on the vehicle, and wherein the lower frame element has an inactive first position lying against the vehicle rear door below the rear window, and wherein the upper frame element surrounds the rear window in the inactive first position thereof.
